(19) United States
(12) Patent Application Publication
(10) Pub. No.: US 2022/0356702 A1
(43) Pub. Date: Nov. 10, 2022

(54) Insulating Element with a Corrugated Surface

(71) Applicant: V21 GmbH, Hamburg (DE)

(72) Inventors: Roland Wiedenroth, Hamburg (DE); Malte Lang, Dahlem (DE)

(21) Appl. No.: 17/760,547

(22) PCT Filed: Sep. 16, 2020
(86) PCT No.: PCT/EP2020/075828

§ 371 Date: Mar. 15, 2022

(30) Foreign Application Priority Data
Sep. 16, 2019 (EP) 19197550.7

(51) Int. Cl. E04B 1/80; C03B 17/02; F16L 59/065

(52) U.S. Cl. CPC E04B 1/803; C03B 17/025; F16L 59/065

(57) ABSTRACT

An insulating element for thermal isolation includes a vacuum cell having a wall with a corrugation.

### FIELD OF THE INVENTION

The invention relates to an insulating element for thermal insulation and to a heat insulation element comprising a plurality of such insulating elements.

### TECHNICAL BACKGROUND

With regard to energy savings in heating and cooling energy consumption, for example of buildings, efficient thermal insulation makes sense. Heat insulation elements are also used in many fields, from refrigerators to the thermal insulation of space capsules.

It is known that a good thermal insulation effect can be achieved by means of a vacuum, for example by an evacuated double wall. This is used, for example, in thermos flasks.

Here, an evacuated volume must structurally withstand the negative pressure of the vacuum, which requires a certain wall thickness of the double wall. However, increasing wall thickness contributes to heat conduction and is therefore disadvantageous with regard to the insulating effect.

US2010330316 A1 teaches a heat insulation element with vacuum cells having a corrugated surface.

### SUMMARY OF THE INVENTION

The invention is defined by the independent claims. One aspect of the invention relates to an insulating element, another aspect of the invention relates to a heat insulation element comprising such insulating elements, and a still further aspect relates to a method of manufacturing such an insulating element.

### BRIEF DESCRIPTION OF THE DRAWINGS

Examples of embodiments of the invention are described by way of example and with reference to the accompanying figures, wherein

FIG. 1 a perspective view of an example of an insulating element with corrugation, and

FIG. 2 illustrates a perspective view of an example of a heat insulation element with multiple layers of insulating elements.

### DETAILED DESCRIPTION

A heat insulation element has one or more vacuum cells, each vacuum cell having a wall with one or more corrugations. A heat insulation element has one or more layers of such insulation elements. Such insulating elements can be manufactured, for example, by melting material and pressing it through an opening into an evacuated chamber as a hollow strand. By constricting the hollow strand, a (closed) vacuum cell is created. By stretching the vacuum cell, its wall thickness is reduced. The wall of the vacuum cell is corrugated.

Evacuated or vacuum means that, in some embodiments, a fluid enclosed in the vacuum cell (gas-tight) has a pressure that is significantly lower than atmospheric pressure under normal conditions. In some embodiments, the pressure in the vacuum cell is less than 10⁵ Pa, 10²PA, 10⁻¹ Pa, 10⁻² Pa, or 10⁻⁴ Pa.

By means of the vacuum cell(s), a low heat conduction and thus a good insulating effect of the insulating element can be achieved. In a heat insulation element several insulating elements are combined, for example arranged as explained below, which simplifies the practical use of insulating elements, for example for the thermal insulation of a building or a technical device.

In some embodiments, the vacuum cell comprises glass. For example, the wall of the vacuum cell is made with glass as the material. For example, the glass is borosilicate glass, quartz glass or aluminium silicate glass. In some embodiments, the vacuum cell, at least the wall thereof, is made with plastic as the material. In some embodiments, the wall is fibre-reinforced, for example by means of carbon fibres or Keflar fibres.

It is known that corrugations can be used to increase the bending flexibility, for example of metal pipelines, i.e. a material that is already elastic or flexible in itself, along a longitudinal direction. However, especially in the case of glass as the material of the vacuum cell, it is a brittle, fragile material. The present invention is based, among other things, on the realisation that an implosion pressure of the vacuum cell can be improved by corrugation, or a smaller wall thickness of the vacuum cell can be realised without damaging the vacuum cell already due to its enclosed vacuum. Thus, the insulating effect of an insulating element and accordingly also of a heat insulation element can be improved. Also, their weight and/or thickness can be reduced. Lighter and/or thinner heat insulation elements, for example in the form of insulation panels, are advantageous for the insulation of residential buildings.

With increasing length of the vacuum cell, a lower specific mass of the heat insulation element, i.e. a “lighter” heat insulation element, can be achieved. For example, the vacuum cell has a length of more than 5 mm, 10 mm, 20 mm, 50 mm, 100 mm, 200 mm, 300 mm or 500 mm. At the same time, or independently, in some embodiments the vacuum cell has a length of no more than 10 mm, 20 mm, 50 mm, 100 mm, 200 mm, 300 mm, 500 mm or 800 mm. Shorter lengths of the vacuum cells increase the robustness of the heat insulation element, for example by reducing the risk of insulating elements being damaged when the heat insulation element is bent. In addition, heat insulation elements made of shorter vacuum cells are easier to process, since, for example, only short vacuum cells are affected when sawing the panel. On the other hand, better insulation properties can be achieved with long vacuum cells.

In some embodiments, the vacuum cell has a thickness, i.e. an (outer) diameter, of more than 3 mm, 5 mm, 8 mm, 10 mm, 20 mm or 30 mm. Simultaneously or independently, in some embodiments, the vacuum cell has a thickness of at most 5 mm, 8 mm, 10 mm, 20 mm, 30 mm or 50 mm.

Preferably, a length of the vacuum cell is greater than its thickness. For example, the length of the vacuum cell is approximately two, three, five, ten, twenty, fifty or one hundred times its thickness.

Length or longitudinal direction are to be understood in this document as corresponding to the direction in which the molten material is pressed in and the hollow strand is stretched during the manufacture of the insulating element. The thickness of the vacuum cell or its diameter are to be understood in a cross-section perpendicular to this.

The wall of a vacuum cell contributes to heat transfer, so a thinner wall of the vacuum cell implies improved insulation. For example, the wall of the vacuum cell has a wall thickness of about 200 μm, 100 μm, 50 μm, 30 μm, 10 μm or 5 μm.

In some embodiments, the wall of the vacuum cell is tubular in shape. In some of these embodiments, the vacuum cell has a substantially cylindrical shape, for example with a circular, hexagonal or octagonal cross-sectional surface.

In some embodiments, the vacuum cell is equipped with exactly one or exactly two or a plurality of corrugations. In some embodiments, the vacuum cell is free of intersections and contact points with respect to the corrugation(s). This allows for easy fabrication of the insulating element. In other embodiments, two or more corrugations or even one and the same corrugation intersect (i.e. cross) or touch each other exactly once or several times. Intersections and contact points of corrugations can provide additional stability to the wall, due to the two-dimensional course of the corrugation when viewed with respect to the wall surface.

In some embodiments, one or more or all of the corrugations extend along the entire length of the vacuum cell. A corrugation thus essentially leads from one end to the other end of the vacuum cell. In some embodiments, several corrugations are distributed, in particular evenly, over the entire length of the vacuum cell.

In some embodiments, one or more or all of the corrugations span the vacuum cell (in a radial direction, i.e. transversely to the longitudinal direction) at least once or several times.

In some embodiments, the corrugation is helical. For example, a helical corrugation extends along a portion or substantially the entire length of the vacuum cell. In some embodiments, the wall of the vacuum cell has two helical corrugations extending along a common longitudinal portion of the vacuum cell, for example in the form of two helices of the same sense running around each other without intersection, or in the form of two helices of opposite sense such that the wall has intersections (i.e. crossings) of corrugations. Helices of the same sense can be produced simultaneously and thus efficiently by a rotational movement, for example. Opposite helices create a cross-linked structure that increases the stability of the vacuum cell.

In some embodiments, the vacuum cell is equipped with one, two or a plurality of annular corrugations. For example, in some embodiments with two or more annular corrugations, the annular corrugations are free of intersections and points of contact, for example, in planes orthogonal to the longitudinal axis of the vacuum cell. In some other embodiments with two or more annular corrugations, the corrugations have intersections, such as a first annular corrugation and a second annular corrugation being at different angles to a plane orthogonal to the longitudinal axis.

In some embodiments, the corrugation(s) is (are) concave (as viewed from outside the vacuum cell). For example, a corrugation represents a (local) deepening, i.e. reduction, of the outer diameter of the vacuum cell (but not a substantial elevation, i.e. local diameter increase). For example, seen from the outside, the corrugation has the shape of a groove running along the outer surface of the vacuum cell. This makes it possible to avoid small-area mutual contact points when several insulating elements are arranged directly adjacent to each other in a heat insulation element. Gaps between adjacent insulating elements can also be avoided.

In some embodiments, the wall has a substantially constant wall thickness on both sides of a corrugation and also in the area of the corrugation, so that the wall thickness is not reduced and thus weakened by the corrugation. A concave corrugation on the outside of the vacuum cell thus causes a convex profile on the inside of the vacuum cell. In some embodiments, the wall of the vacuum cell has a (substantially) uniform wall thickness.

In some embodiments, the corrugation represents a depression on the outer surface of the insulating element, more specifically the wall of the vacuum cell, that is more than 1 times, 10 times, 100 times or 1000 times the wall thickness. A deformation increasing in these orders of magnitude increasingly increases the strength of the vacuum cell. In some embodiments, the corrugation is a depression on the outer surface of the insulating element, more specifically a depression of the wall of the vacuum cell, that is less than 1, 10, 100 or 1000 times the wall thickness.

In some embodiments, essentially a noble gas is provided as the residual gas in the vacuum of the vacuum cell for a better insulating effect.

In some embodiments, the wall of the vacuum cell is coated with a reflective coating, for example an infrared light reflective coating, wherein for example the outer surface of the wall is coated.

In some embodiments, the insulating element has two or more vacuum cells. If a breach occurs in one vacuum cell, the remaining vacuum cells of the insulating element each retain their vacuum, so that the insulating element as a whole loses only part of its insulating effect. For example, the two or more vacuum cells are arranged in a string, similar to a string of pearls, along the longitudinal direction of the insulating element. For example, the vacuum cells arranged one behind the other in a string are arranged with substantially no space between them.

In some embodiments, to produce an insulating element with two or more vacuum cells, the hollow strand is constricted only to the extent that the inner cavity of the hollow strand is sealed gas-tight and thus a vacuum cell is formed without cutting the hollow strand.

In some embodiments, the insulating elements are aligned parallel to each other in one position of the heat insulation element; for example, one position of the heat insulation element is determined by insulating elements arranged parallel in one plane. This allows the heat insulation element to be curved transversely to the longitudinal direction of the insulating elements arranged in parallel, for example partially rolled up, for example in order to thermally insulate pipelines with the heat insulation element.

In some embodiments, the insulating elements are arranged in a layer essentially free of interstitial space. Heat can thus only pass through the insulating elements so that their insulating effect is efficiently utilised.

In some embodiments, in one layer of the heat insulation element, the insulating elements are arranged in a lying manner. For example, the thickness of a layer corresponds essentially to the thickness of an insulating element.

In some embodiments, two or more insulating elements are arranged in a row (along their longitudinal direction) in one layer of the heat insulation element. This makes it possible to create heat insulation elements with a desired length that is longer than the length of the individual insulation elements.

In some embodiments, at least two (transversely) adjacent insulating elements are longitudinally offset from each other by an offset different from the length of a vacuum cell or a multiple thereof. In this way, adjacent vacuum cells are offset along their longitudinal direction so that thermal bridges perpendicular thereto are avoided.

In some embodiments, the heat insulation element has two or more layers of insulating elements, wherein the insulating elements of adjacent layers are aligned parallel to each other. For example, the insulating elements of one layer are arranged in a densest packing relative to the insulating elements of an adjacent layer. For example, adjacent layers overlap here, in which insulating elements of one layer protrude into gaps between insulating elements of an adjacent layer. This makes it possible to achieve a homogeneous structure of the heat insulation element and to avoid thermal bridges between the layers.

In some embodiments, the insulating elements are arranged flush with each other in one layer of the heat insulation element. In some of these embodiments, the respective flush insulating elements of adjacent layers are arranged offset from each other.

In some embodiments, two or more layers are combined into a package, wherein the heat insulation element comprises at least two packages. For example, two or more packages are stacked so that the heat insulation element has a number of layers equal to the sum of the layers of the stacked packages.

In some embodiments, the insulating elements of individual packs of the heat insulation element are each arranged flush with each other and offset from the insulating elements of adjacent packs.

In some embodiments, an infrared light reflecting layer is provided between at least two adjacent layers of the thermal barrier element, for example in the form of a foil disposed between the adjacent layer.

In some embodiments, the heat insulation element is equipped with a support element to protect the insulating elements from mechanical stresses, for example bending or penetration of foreign bodies. For example, the support element comprises a plastic, hard paper, wood or metal layer that substantially covers the insulating elements of the heat insulation element.

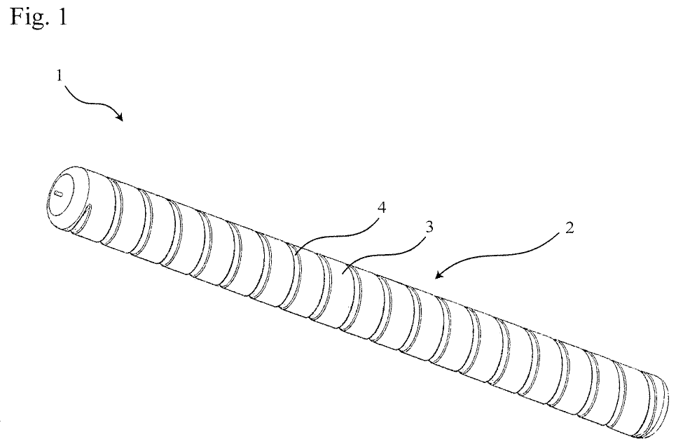

FIG. 1 shows an example insulating element 1 made of glass for thermal insulation with exactly one vacuum cell 2. A wall 3 of the vacuum cell 2 is tubularly made of a hollow strand which was constricted at both ends of the vacuum cell 2 during manufacture in order to seal the vacuum cell 2 gas-tight. This was done under vacuum so that an insulating vacuum prevails in the vacuum cell 2.

The (glass) wall 3 is provided with a helical corrugation 4 that extends over the entire length of the vacuum cell 2. The vacuum cell 2 has an essentially constant wall thickness throughout, which can be adjusted by suitable stretching when manufacturing the insulating element 1 from a hollow strand. Apart from the respective local deformations along the corrugation 4, the wall 3 has a circular cross-section throughout.

The corrugation 4 gives the wall 3 additional mechanical stability, which the vacuum cell 2 would not have without the corrugations 4. This makes the insulating element 1 more robust against external mechanical influences and/or allows it to be realised with thinner walls than comparable insulating elements without corrugation.

The corrugation 4 of the vacuum cell 2 is produced by locally heating the wall 3 along the desired path of the corrugation 4 with a laser, so that the corrugation 4 is created by bending the wall 3 inwards. Viewed from the outside, the corrugation 4 is concave and therefore does not increase the diameter of the vacuum cell 2. In this example, the corrugation 4 is therefore produced without material removal and without moulds.

To increase the insulating effect, the wall 3 can be provided with an infrared reflecting coating, for example by vapour-depositing a thin metal layer.

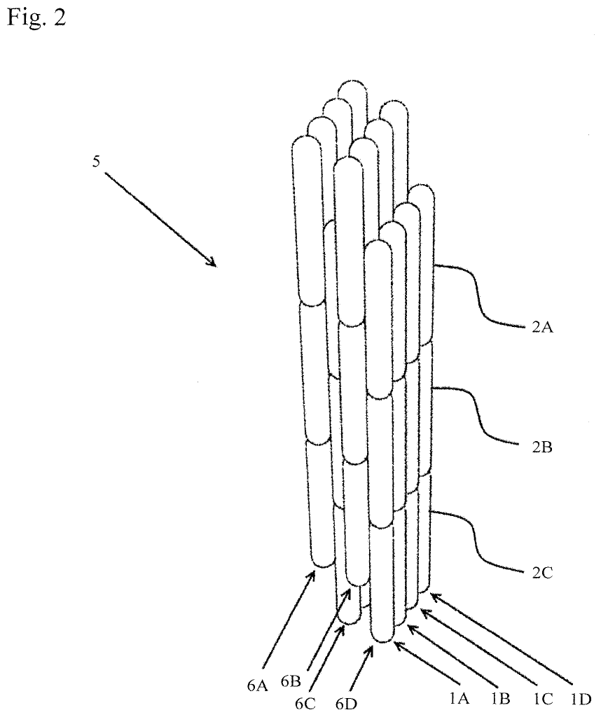

FIG. 2 shows a perspective view of a section of a heat insulation element 5 with four layers 6A, 6B, 6C, 6D, wherein in each layer 6A, 6B, 6C, 6D insulating elements 1A, 1B, 1C, 1D are arranged parallel to each other in one plane and directly adjacent to each other, i.e. free of gaps. The insulating elements 1A, 1B, 1C, 1D differ from the one shown in FIG. 1 in that they each have (in the longitudinal direction) three individual vacuum cells 2A, 2B, 2C contiguous in one strand. The insulating elements 1A, 1B, 1C, 1D were made from a hollow strand of molten material, e.g. glass, whereby the hollow strand was constricted along an insulating element 1A, 1B, 1C, 1D at two points in such a way that a total of three mechanically connected vacuum cells 2A, 2B, 2C are formed, which each provide separate vacuum volumes, i.e. a gas exchange between the vacuum cells 2A, 2B, 2C takes place. i.e. there is no gas exchange between the vacuum cells 2A, 2B, 2C or between a vacuum cell 2A, 2B, 2C and the environment. During the manufacture of such insulating elements 1A, 1B, 1C, 1D, the hollow strand at the end of the insulating element is, as it were, constricted to a greater extent and thus unravelled. In this way, a suitable sequence of less severe constrictions and reinforced constrictions makes it easy to achieve a desired number of vacuum cells per insulating element and also to adjust a length of the vacuum cells.

Corrugations of the walls of the vacuum cells are not shown in FIG. 2 for clarity, but each of the vacuum cells 2A, 2B, 2C is equipped with a corrugation as explained in FIG. 1. Other example insulating elements not shown differ from this only in the shape of the corrugation(s), whereby the various designs described above are used with regard to the corrugation(s).

Returning to FIG. 2, the heat insulation element 5 must be thought of as being continued along both spatial dimensions of the layers 6A, 6B, 6C, 6D by further directly adjacent insulating elements 1A, 1B, 1C, 1D, i.e. one or more further insulating elements follow the insulating elements 1A, 1B, 1C, 1D shown (along a row) in the longitudinal direction. Likewise, viewed in the plane of the respective layer 6A, 6B, 6C, 6D, further insulating elements follow laterally adjacent in each case.

In the heat insulation element 5 shown in FIG. 2, the insulating elements 1A, 1B, 1C, 1D of a layer 6A, 6B, 6C, 6D are each aligned flush with one another, with insulating elements 1A, 1B, 1C, 1D of adjacent layers 6A, 6B, 6C, 6D being offset along the longitudinal direction of the insulating elements 1A, 1B, 1C, 1D, for example by half the length of a vacuum cell 2A, 2B, 2C. In other examples, adjacent insulating elements 1A, 1B, 1C, 1D in a layer 6A, 6B, 6C, 6D and/or relative to those of adjacent layers 6A, 6B, 6C, 6D are arranged non-flush, for example varying regularly or irregularly/randomly.

Because the heat insulation element 5 is made up of individual insulating elements 1A, 1B, 1C, 1D, each with vacuum cells 2A, 2B, 2C that are independent of each other in terms of vacuum, only local vacuum cells 2A, 2B, 2C are damaged in the event of mechanical impact on the heat insulation element 5, such as an impact, drilling a hole or penetrating sharp objects (e.g. a nail), and the heat insulation element 5 loses only a small amount of its insulating effect overall.

With reference to FIGS. 1 and 2, example manufacturing processes for the insulating elements and heat insulation elements described above are explained below. A material, for example glass or plastic, is melted and pressed into an evacuated chamber. For example, the material is pressed through a mould into the chamber in a continuous process. This mould forms, for example, one or more hollow strands such that one or more hollow strands emerge from this mould having a corresponding cross-section, for example circular, hexagonal or octagonal. Thus, in some examples, the mould allows multiple hollow strands to be produced simultaneously. For the sake of clarity, only one hollow strand is described below.

The chamber is evacuated to the desired vacuum that is to prevail later in the vacuum cells of the insulating elements or can, for example, still have a residual pressure of special gases, such as noble gases, or of air.

The material formed into a hollow strand is mechanically stretched after leaving the mould to achieve a (desired thin and uniform) wall thickness.

In order to create several vacuum cells per insulating element, the (stretched) hollow strand is constricted at regular intervals, for example by means of mechanical devices such as impellers, i.e. its diameter is locally tapered so that the inner volume of the hollow strand is closed, i.e. a vacuum cell is formed in which the pressure of the evacuated chamber is then conserved. The sequence of the process steps can also be different: first necking, then stretching, or first stretching and then necking. The material cools down and hardens in the further course.

In order to produce a layer with insulating elements of the heat insulation element, a plurality of insulating elements can be produced separately and then arranged in a plane as previously described. For example, the insulating elements can be glued together or held by a common sheath or cast in place.

In some examples, several or even all of the insulating elements of a layer can be pressed in the chamber at the same time, so that adjacent insulating elements already melt together in the chamber, thus forming a coherent flat structure of parallel insulating elements. In this way, an entire layer or a partial layer can be produced in one pressing process.

To produce a multi-layered heat insulation element, several layers of insulating elements are placed on top of each other and joined together to form the heat insulation element, for example, loosely laid on top of each other and joined together by a cover of the heat insulation element, glued together or melted together under the influence of heat.

In manufacturing variants with melting together, contact areas between adjacent insulating elements can be made larger or smaller depending on the temperature and the resulting viscosity of the material. For example, if the insulating elements are already almost hardened when they are placed next to or on top of each other, they hardly change their shape, so that the contact areas remain small and the cross-section of the insulating elements remains essentially circular.

In some examples, the layers of a heat insulation element are provided with a protective sheath and/or the spaces between the layers or insulating elements are filled with a bonding material. Suitable bonding materials and/or protective sheaths include plastics, such as polystyrene, liquid wood or epoxy resins. For example, the material properties of the protective sheath are selected so that they fulfil a function suitable for the intended use, for example as an adhesion promoter for plasters.

In some examples, the protective cover of the heat insulation elements is provided with a circumferential profile, for example a tongue-and-groove profile, in order to be able to string together several heat insulation elements without thermal bridges or also in order to hold or connect them to each other by positive locking.

1. Insulating element for thermal insulation, comprising a vacuum cell, wherein the vacuum cell has a wall which has a corrugation.

2. Insulating element according to claim 1, wherein the wall is tubular.

3. Insulating element according to claim 1, wherein the corrugation is helical.

4. Insulating element according to claim 1, wherein the corrugation extends along the entire length of the wall and/or completely encompasses the wall at least once.

5. Insulating element according to claim 1, wherein the vacuum cell has a circular, hexagonal or octagonal cross section.

6. Insulating element according to claim 1, wherein the vacuum cell comprises glass.

7. Insulating element according to claim 1, wherein the wall has a uniform wall thickness.

8. Insulating element according to claim 1, wherein the corrugation is concave.

9. Insulating element according to claim 1, wherein the wall has a coating which reflects infrared light.

10. Heat insulation element which has a layer comprising insulating elements according to claim 1.

11. Heat insulation element according to claim 10, wherein the layer comprises rows of insulating elements arranged in parallel.

12. Heat insulation element according to claim 10 wherein in the case of two adjacent rows of insulating elements, insulating elements of different rows are arranged so as to be offset with respect to one another in the longitudinal direction.

13. Heat insulation element according to claim 10, wherein the layer is one layer of two or more layers arranged as one or more pairs of adjacent layers, wherein the insulating elements of adjacent layers are aligned in parallel with one another.

14. Heat insulation element according to claim 13, wherein the insulating elements of adjacent layers are arranged in a closest packing arrangement.

15. Method for producing an insulating element, comprising:
melting material,
pressing the molten material through an opening into an evacuated chamber as a hollow strand,
constricting the hollow strand, such that a vacuum cell is formed,
stretching the strand, such that the wall thickness of the vacuum cell is reduced, and
corrugating the wall of the vacuum cell.
